(19) United States
(12) Patent Application Publication
(10) Pub. No.: US 2021/0272050 A1
(43) Pub. Date: Sep. 2, 2021

(54) PHOTOGRAPHING MECHANISM CONTROL APPARATUS AND PHOTOGRAPHING MECHANISM CONTROL METHOD

(71) Applicant: TOSHIBA TEC KABUSHIKI KAISHA, Tokyo (JP)

(72) Inventors: Keita YAMAZAKI, Mishima (JP); Masaaki YASUNAGA, Sunto (JP)

(73) Assignee: TOSHIBA TEC KABUSHIKI KAISHA, Tokyo (JP)

(21) Appl. No.: 17/177,843

(22) Filed: Feb. 17, 2021

(30) Foreign Application Priority Data
Mar. 2, 2020 (JP) 2020-034828

(51) Int. Cl. G06Q 10/08; G06K 7/14

(52) U.S. Cl. CPC G06Q 10/087; G06K 7/1417

(57) ABSTRACT

A photographing mechanism control apparatus includes an interface, and a processor. The interface communicates with a photographing mechanism that is moved to a position according to an instruction to photograph a shelf for storing commodities, and the processor detects presence of a moving object in a vicinity of a shelf, if the presence of the moving object is detected, gives an instruction to the photographing mechanism to photograph the shelf through the interface, acquires image data from the photographing mechanism through the interface, and confirms whether or not a commodity is stored on the shelf based on the image data.

### CROSS-REFERENCE TO RELATED APPLICATION

This application is based upon and claims the benefit of priority from Japanese Patent Application No. 2020-034828, filed on Mar. 2, 2020, the entire contents of which are incorporated herein by reference.

### FIELD

Embodiments described herein relate generally to a photographing mechanism control apparatus.

### BACKGROUND

Recently, an apparatus that photographs a product display shelf in a store and a warehouse using a movable photographing mechanism with a camera mounted thereon and detects the shortage state or out of stock is being developed.

However, since the number of product display shelves is generally large, there is a problem that it takes time to grasp a shortage state or out of stock of products in all the product display shelves.

### DESCRIPTION OF THE DRAWINGS

FIG. 1 is a view schematically illustrating an overall image of a photographing mechanism control system according to at least one embodiment;

FIG. 2 is a block view schematically illustrating a configuration of a photographing mechanism control apparatus according to at least one embodiment;

FIG. 3 is a block diagram schematically illustrating a configuration of a photographing mechanism according to at least one embodiment;

FIG. 4 is a flowchart for illustrating processing by the photographing mechanism control apparatus according to at least one embodiment; and

FIG. 5 is a flowchart for illustrating an operation of the photographing mechanism according to at least one embodiment.

### DETAILED DESCRIPTION

An object is to provide a photographing mechanism control apparatus and a photographing mechanism control method capable of efficiently understanding a shortage state or out of stock of products state in a store and a warehouse.

In general, according to at least one embodiment, there is provided a photographing mechanism control apparatus includes an interface, and a processor. The interface communicates with a photographing mechanism that is moved to a position according to an instruction to photograph a shelf for storing commodities, and the processor detects presence of a moving object in a vicinity of a shelf, if the presence of the moving object is detected, gives an instruction to the photographing mechanism to photograph the shelf through the interface, acquires image data from the photographing mechanism through the interface, and confirms whether or not a commodity stored on the shelf based on the image data.

Hereinafter, at least one exemplary embodiment will be described with reference to the drawings.

Configuration

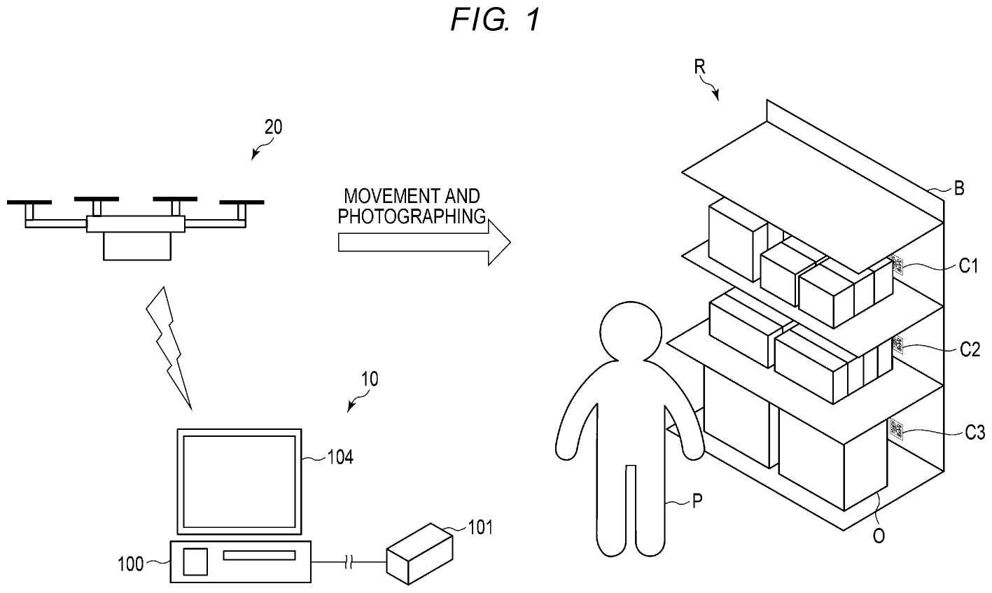

FIG. 1 is a view schematically illustrating a configuration of a photographing mechanism control system. The photographing mechanism control system includes a photographing mechanism control apparatus (controller) 10 and a photographing mechanism 20. The photographing mechanism control system is applied to a photographing area (for example, a store or a warehouse) in which a rack R accommodating a wide variety of products O is placed. In FIG. 1, one rack R is illustrated for convenience, but there may be a plurality of racks R.

In the photographing area, a person P (customer or clerk) can move freely, and the person P can approach the rack R and pickup the product O. The rack R is, for example, a multi-stage shelf having a plurality of horizontal shelves and corresponds to a product display shelf or a product storage shelf on which various products O can be placed on each shelf board. In addition, on a back plate B of the rack R, printed matter of unique two-dimensional data codes C1 to Cn associated with the products O placed on the shelf boards (hereinafter, simply referred to as “two-dimensional data codes C1 to Cn”) is attached.

The two-dimensional data codes C1 to Cn area attached to the back plate B such that part or all of the two-dimensional data codes cannot be seen from an aisle side by the product O on the shelf board, and if the product O is out of stock or the number of the products is reduced, the two-dimensional data codes are attached to the back plate B such that all of the two-dimensional data codes can be read mechanically from the aisle side.

For example, it is possible to detect the out of stock or shortage state of products O by the technique published in Japanese Patent Application No. 2017-157032. In the photographing mechanism control system, the technique published in Japanese Patent Application No. 2017-157032 can be adopted, but other techniques may be applied to read the two-dimensional data codes C1 to Cn.

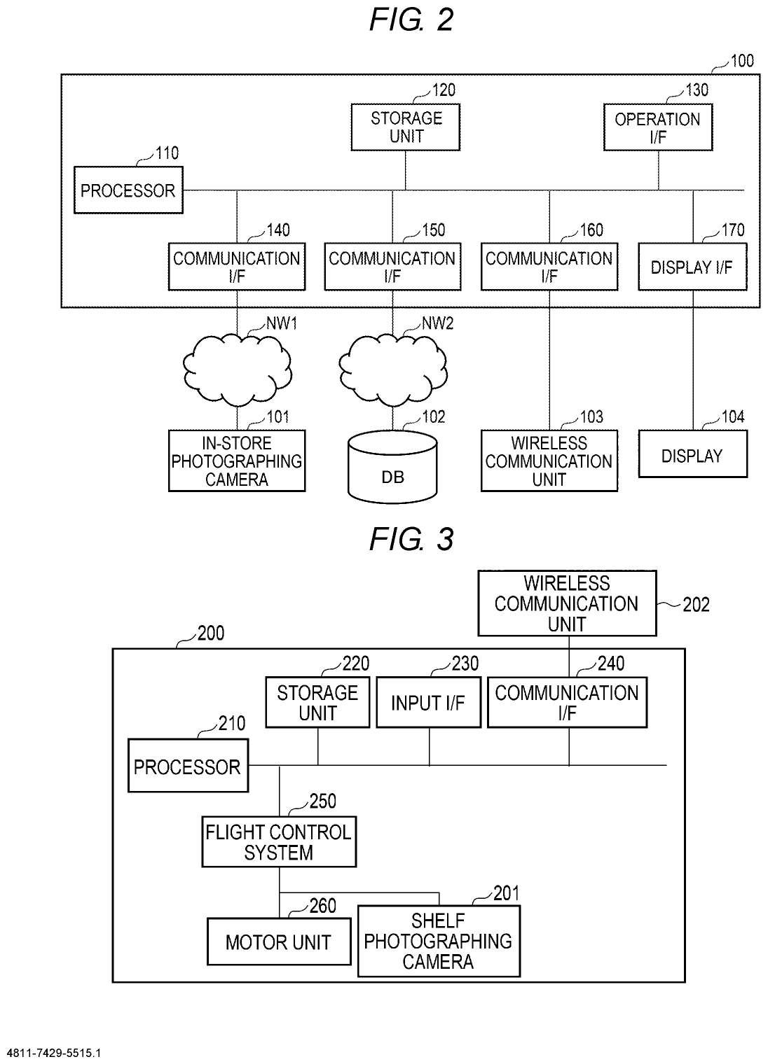

Next, the configuration of the photographing mechanism control apparatus 10 will be described with reference to FIG. 2.

The photographing mechanism control apparatus 10 is an information processing apparatus using a computer such as a personal computer or a server and executes information processing based on the control (movement and photographing) of a photographing mechanism 20 described later and the image data photographed by the photographing mechanism 20. The photographing mechanism control apparatus 10 includes a control unit 100, a wireless communication unit 103, and a display 104.

The control unit 100 includes a processor 110, a storage unit 120, an operation interface (operation I/F) 130, a communication interfaces (communication I/Fs) 140 to 160, and a display I/F 170. These configurations are connected by a control bus and are collectively controlled by the processor 110.

The processor 110 includes a CPU (Central Processing Unit), a cache memory, and the like, operates by reading the basic software (OS (Operating System)), control data, and application software stored the storage unit 120, and controls each unit of the photographing mechanism control apparatus 10.

More specifically, the processor 110 can analyze the image data to determine whether or not a person is included in a photographed image, whether or not the captured person is a customer, whether or not the customer is holding the product O, and the like. In addition, it is possible to move the photographing mechanism 20 if necessary, photograph a desired rack R, analyze the image, and detect the out of stock or shortage state of the product O.

The storage unit 120 is configured by a storage device such as a Read Only Memory (ROM), a Random Access Memory (RAM), a Hard Disk Drive (HDD), or a Solid State Drive (SSD), and may store the basic software, control data, application software, and image data according to the characteristics of each storage device, as well as management data and the like. In addition, a CD driver may be provided.

The management data includes information, such as, position information of the rack R, identification information of the product O placed on the rack R, and the two-dimensional data code (any of C1 to Cn) associated with the product O, identification information of an in-store photographing camera 101 used for the photographing of the rack R, position information of the in-store photographing camera 101, and photographing setting information, associated with the identification information of the rack R. The photographing setting information includes setting information such as the direction when photographing the rack R by the in-store photographing camera 101 (pan and tilt information), and the degree of zoom (angle of view).

The operation interface (operation I/F) 130 is an interface for connecting human interfaces such as a keyboard and a mouse, a trackball, and a touch panel mounted on a display 104 described later, and receives an instruction or input from an operator to notify the instruction or input to the processor 110. These human interfaces are not illustrated, but are provided in one or more embodiments.

The communication interfaces (communication I/F) 140 to 160 are an interface for connecting an external device by wire. The communication I/F 140 is, for example, a wired LAN interface, and is connected to the in-store photographing camera 101 via a network NW1. The communication I/F 150 is, for example, a wired LAN interface, and is connected to a database 102 installed outside via a network NW2. The communication I/F 160 is connected to the wireless communication unit 103.

The in-store photographing camera 101 may be, for example, a digital video camera that photographs a moving image using a photographing element such as Complementary MOS (CMOS). In addition, the in-store photographing camera 101 is a network camera having a communication function using a wired LAN. The in-store photographing camera photographs a moving image according to the instruction from the control unit 100 through the network NW1 and transmits the image data obtained by the photographing to the control unit 100 through the network NW1.

Further, the in-store photographing camera 101 includes a drive mechanism (pan, tilt, zoom) that changes the photographing composition according to the instruction from the control unit 100. Then, the in-store photographing camera 101 is arranged so that the rack R installed in the photographing area can be photographed without exception. If a large number of racks R are installed over a wide area or if it is necessary to photograph a large number of racks R at the same time, a plurality of in-store photographing cameras 101 are laid. In the case where the plurality of in-store photographing cameras are present, unique identification information may be given to each in-store photographing camera 101, and the in-store photographing cameras are identified by the control unit 100 and controlled individually.

The database 102 is an information processing apparatus such as a server, and in addition to data for image recognition processing by the control unit 100, update data for updating various software used by the control unit 100, management data generated by the control unit 100, and control log data of the control unit 100, image data for backup and the like are collected and stored.

The wireless communication unit 103 may be a wireless device for wireless communication with the photographing mechanism 20. The wireless communication unit transmits a control signal for controlling the photographing mechanism 20 and receives transmitted image sent from the photographing mechanism 20 using, for example, a 2.4 GHz band and a 5.7 GHz band.

The display 104 is a display such as a liquid crystal monitor, is connected to the control unit 100 via the display interface (display I/F) 170, and displays, for example, Graphical User Interface (GUI) for receiving an operation by an operator, the operation state of the photographing mechanism control system (inventory state, out of stock, and shortage state of products), an image photographed by the in-store photographing camera 101, an image photographed by the photographing mechanism 20, various data generated by the control unit 100, and the like.

Next, an arrangement of the photographing mechanism 20 will be described with reference to FIG. 3.

The photographing mechanism 20 is, for example, an unmanned mobile photographing device such as a drone, and is moved to the vicinity of the rack R instructed by the photographing mechanism control apparatus 10 to photograph the rack R, and image data obtained by the photographing is wirelessly transmitted to the photographing mechanism control apparatus 10.

The photographing mechanism 20 includes a shelf photographing camera 201, a wireless communication unit 202, a processor 210, a storage unit 220, an input interface (I/F) 230, a communication interface (I/F) 240, a flight control system 250, and a motor unit 260. These arrangements are connected by a control bus, and each unit is controlled by the processor 210.

The processor 210 includes a CPU, a cache memory, and the like, reads and operates basic software (OS), control data, and application software stored in the storage unit 220, and controls each unit of the photographing mechanism 20 in an integrated manner.

The storage unit 220 is configured by a storage device such as a ROM, a RAM, or a memory card, and stores basic software, control data, application software, image data, and the like according to the characteristics of each storage device.

The input interface (I/F) 230 is an interface for connecting an external device such as Universal Serial Bus (USB), and for example, is used to connect a laptop-type PC and perform maintenance such as operation settings of the photographing mechanism 20, updates of various programs and software, and acquisition of operation information.

The communication interface (I/F) 240 is an interface for connecting the wireless communication unit 202. The wireless communication unit 202 is a wireless device for communicating with the wireless communication unit 103 of the photographing mechanism control apparatus 10 described above, and similar to the wireless communication unit 103, for example, using a 2.4 GHz band and a 5.7 GHz band, receives a control signal from the photographing mechanism control apparatus 10 and transmits an image to the photographing mechanism control apparatus 10.

The flight control system 250 drives and controls the motor unit 260 to fly the photographing mechanism 20. In addition, the flight control system 250 recognizes the position of the photographing mechanism 20 by using a self-position estimation technique such as Simulation Localization and Mapping (SLAM), moves the photographing mechanism 20 to the position specified by the processor 210, and controls the shelf photographing camera 201 to photograph the desired rack R shelf. For the self-position estimation, the flight control system 250 may include a Global Navigation Satellite System (GNSS) receiver, a gyro, an accelerometer, or other devices that implement a position confirmation method.

The motor unit 260 includes a plurality of motors, to which propellers and the like are connected, is driven and controlled by the flight control system 250, and is used to move the photographing mechanism 20 horizontally and vertically and to control posture.

The shelf photographing camera 201 is a digital camera that photographs an image using, for example, a photographing element such as CMOS. More specifically, the shelf photographing camera 201 photographs products O placed on the shelf board of the desired rack R according to the instruction form the photographing mechanism control apparatus 10 via the flight control system 250. If the product O is out of stock or the number of products is small, the two-dimensional data codes C1 to Cn attached to the back plate B of the rack R are photographed by the shelf photographing camera 201.

Description of Operation

Next, the operation of the photographing mechanism control system having the above configuration will be described.

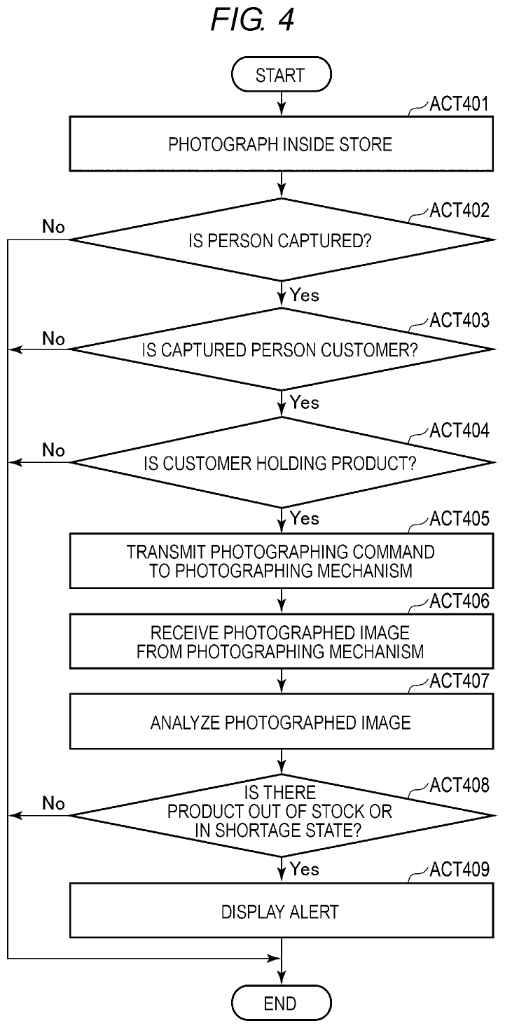

First, the operation of the photographing mechanism control apparatus 10 will be described with reference to FIG. 4. The processing shown in FIG. 4 is a control function realized by the processor 110 reading and executing the application software stored in the storage unit 120. The processing shown in FIG. 4 is repeatedly executed at a preset cycle, and the presence or absence of the product O (out of stock or shortage) placed on the rack R is monitored. If a plurality of in-store photographing camera 101 exist, the processing shown in FIG. 4 is repeatedly executed for each camera at a predetermined cycle.

First, in ACT 401, the processor 110 gives a photographing instruction to the in-store photographing camera 101 through the communication I/F 140 and the network NW1. In response to this instruction, the in-store photographing camera 101 photographs the rack R assigned in advance and transmits the photographed image to the photographing mechanism control apparatus 10. The processor 110 acquires the image data photographed by the in-store photographing camera 101 through the communication I/F 140, and the process proceeds to the ACT 402.

Here, if the image is continuously photographed without waiting for the instruction from the photographing mechanism control apparatus 10 and the instruction is received from the photographing mechanism control apparatus 10, the in-store photographing camera 101 may transmit the latest photographed image data to the photographing mechanism control apparatus 10.

In ACT 402, the processor 110 analyzes the image data acquired by the ACT 401 and determines whether or not the person P is captured. Here, if it is determined that the person P is captured, the process proceeds to ACT 403, while if it is determined that the person P is not captured, the process is ended.

In ACT 403, the processor 110 determines whether or not the captured person P is a customer. The determination of whether or not the person P in the image is a customer is performed by using a well-known technique (for example, template matching) using the uniform of a clerk or an image of some visual identification information worn by the clerk, and if the person is not a clerk, it is determined that the person is regarded as a customer. Here, if the person P is determined to be a customer, the process proceeds to ACT 404, while if it is determined that the person P is not a customer, the process is ended.

In ACT 404, the processor 110 determines whether or not the customer (person P) is holding the product O. In the determination of whether or not the customer (person P) is holding the product O, a portion presumed to be the arm is detected from the image of the peripheral portion of the person P, and whether or not the product O is present in the portion corresponding to the hand is determined. Regarding the estimation of the arm, a portion estimated to be the arm is detected by a well-known technique (for example, a skeleton estimation technique) using an image of some visual identification information.

For the product O, an image recognition technique such as pattern matching with a model image of the product prepared in advance is applied. In addition, it may be determined that the customer holds the product when the position of the portion corresponding to the hand is moved by a distance equal to or larger than a preset threshold value. If it is determined that the customer (person P) is holding the product O, the process proceeds to ACT 405, while if it is determined that the customer (person P) is not holding the product O, the process is ended.

In ACT 405, the processor 110 refers to the management data stored in the storage unit 120 and specifies the position of the rack R that is an object to be processed (acquires the position information). Then, the processor 110 transmits a photographing command including the above position information to the photographing mechanism 20 through the communication I/F 160 and the wireless communication unit 103, and the process proceeds to ACT 406. The photographing command includes the position and altitude at which the photographing mechanism 20 stays when photographing, as the position information, and also includes photographing information designing the photographing direction and zoom (angle of view) by the shelf photographing camera 201.

In ACT 406, the processor 110 receives image data (photographed image) wirelessly transmitted from the photographing mechanism 20 in response to the photographing command through the wireless communication unit 103 and the communication I/F 160, and the process proceeds to the ACT 407. The image data includes identification information uniquely given to the photographing command, and based on this identification information, it can be recognized that the image data corresponds to the photographing command transmitted in ACT 405.

In ACT 407, the processor 110 analyzes the photographed image of the image data received in ACT 406 and the process proceeds to ACT 408. In the analysis, it is analyzed whether or not a two-dimensional data code (any of C1 to Cn) is captured in the photographed image.

In ACT 408, the processor 110 determines whether or not there is a product O out of stock or in a shortage state based on the analysis result of ACT 407. If the two-dimensional data code is captured in the above analysis result (when the two-dimensional data code can be read), it is determined that the product O is out of stock. The technique disclosed in paragraphs [0009] to [0021] of Japanese Patent Application Laid-Open No. 2017-157032 can be applied to this determination.

Further, in order to determine the shortage of the product O by the above analysis, the technique disclosed in WO2015/136847A1 can be applied. Specifically, it is determined whether or not the line drawn by the surface of the product O placed on the shelf board of the rack R facing the photographing mechanism 20 is, for example, a curved line. Here, if it is determined that the product O is out of stock or in a shortage state, the process proceeds to ACT 409, while if it is determined that there is no product O out of stock or in a shortage state, the process is ended.

In ACT 409, the processor 110 communicates an alert (e.g., by a display function) indicating that the product O is out of stock or in a shortage state on the display 104 through the display I/F 170 together with a display indicating the product name, the position of the rack R, and the shelf stage of the shelf board in the rack R, and notifies the operator of the displayed content.

In addition, the processor 110 edits the management data and gives a flag to the product O which is out of stock or in a shortage state. Further, the processor 110 updates the management data on the database 102 through the communication I/F 150, and ends the process.

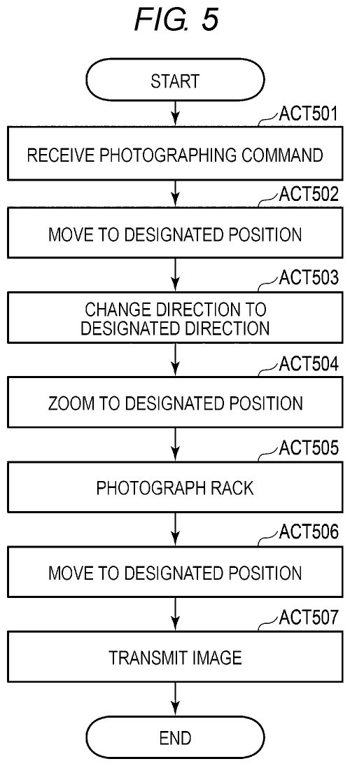

Next, the operation of the photographing mechanism 20 will be described with reference to FIG. 5. The processing shown in FIG. 5 is a control function realized by reading and executing the application software stored in the storage unit 220 by the processor 210 and may be repeatedly executed at a predetermined cycle.

First, in ACT 501, the processor 210 controls the wireless communication unit 202 through the communication I/F 240 and receives the transmitted photographing command in ACT 405 in FIG. 4. If the processor cannot receive the command, the processor waits for reception of the command. If the processor receives the photographing command, the process proceeds to ACT 502.

In ACT 502, processor 210 decodes the position information and the photographing information included in the photographing command, determines the position and altitude at which the photographing mechanism 20 stays when photographing, and the photographing direction and zoom (angle of view) by the shelf photographing camera 201. Then, the processor 210 gives an instruction to the flight control system 250 to move the photographing mechanism 20 to the designated position and altitude, and the process proceeds to ACT 503. Thus, the flight control system 250 drives and controls the motor unit 260 to move the photographing mechanism 20 to the position and altitude according to the photographing command (position information).

In ACT 503, the processor 210 gives an instruction to the flight control system 250 to direct the photographing direction of the photographing mechanism 20 to the desired direction according to the photographing information acquired in ACT 502, and the process proceeds to ACT 504. Thus, the flight control system 250 drives and controls the motor unit 260 to set the photographing direction of the photographing mechanism 20 to the desired direction.

In ACT 504, the processor 210 gives an instruction to the flight control system 250 to set the photographic angle of view of the photographing mechanism 20 according to the photographing information acquired in ACT 502, and the process proceeds to ACT 505. Thus, the flight control system 250 drives and controls the zoom motor (not illustrated) of the shelf photographing camera 201 to set the photographic angle of view, and the rack R is included in the photographic angle of view.

In ACT 505, the processor 210 gives an instruction to the flight control system 250 to perform photographing if the setting of the photographic angle of view is completed, and the process proceeds to ACT 506. Thus, if the setting of the photographic angle of view is completed, the flight control system 250 controls the shelf photographing camera 201 to photograph the rack R.

In ACT 506, processor 210 gives an instruction to the flight control system 250 to move to a preset designated position when photographing is completed, and the process proceeds to ACT 507. Thus, if the photographing of the rack R is completed, the flight control system 250 drives and controls the motor unit 260 to move to the above-mentioned designated position and moves the photographing mechanism 20 to the above-mentioned designated position. If the flight control system 250 detects the movement to the designated position, the flight control system notifies the processor 210 of the effect.

In ACT 507, if the processor 210 receives the notice that the flight control system 250 is moved to the designated position, the processor 210 wirelessly transmits the image data of the rack R photographed by the shelf photographing camera 201 in ACT 505 to the photographing mechanism control apparatus 10 through the communication I/F 240 and the wireless communication unit 202. The image data to be wirelessly transmitted includes the identification information of the photographing command received in ACT 501.

### SUMMARY

As described above, the photographing mechanism control system having the above arrangement gives a command to the photographing mechanism 20 to photograph the portion of the rack R in which the product O is stored if the photographing mechanism control apparatus 10 detects a customer is holding the product O from the image in which the rack R is photographed by the in-store photographing camera 101, and detects the out of stock or shortage state of the product O based on the image photographed by the photographing mechanism 20 according to the command.

Therefore, according to the photographing mechanism control system having the above arrangement, only for the rack R where the customer is likely to have brought out the product O, the photographing mechanism 20 performs photographing to confirm the out of stock or shortage state (i.e., low stock) of the product O. Thus, it is possible to efficiently understand the inventory status of the products in the store and warehouse, and quickly understand the shortage state (e.g., wherein the stock is below a threshold state) and out of stock state of products.

In at least one embodiment, the description is made on the assumption that the customer is holding the product O in order to purchase the product at the store, but embodiments are not limited thereto. It is also possible for the clerk to replenish or replace the product. Therefore, ACT 405 and the subsequent processes may be executed when the person P holds the product O without distinguishing between the customer and the clerk (ACT 403 is omitted). In particular, in the warehouse and the store backyard, it is not necessary to determine a customer since the clerk is an object to be monitored.

In at least one embodiment, although it is determined whether or not the person P is holding the product O, this determination (ACT 404) may be omitted. Thus, the processing load and cost of the photographing mechanism control apparatus 10 can be suppressed.

If the customer determination and the determination of holding is omitted, the approach of the person P to the rack R may be determined based on the information other than the image of the in-store photographing camera 101. For example, a motion sensor using infrared rays may be used.

In addition, automatic transportation robots (or inventory robots, etc.) may be introduced in distribution centers, distribution warehouses, warehouses that manage files and books, and the like. In at least one embodiment, in ACTs 401 to 403, the behavior of person P as a moving object to be monitored is monitored. However, the automatic transport robot approaching the rack R, the shopping cart used by the person P may be detected, or the automatic transport robot or the shopping cart may be tracked to move or stop.

Further, in the embodiment, an examples assuming a drone as the photographing mechanism 20 is described, but the embodiment is not limited thereto. The photographing mechanism 20 is not limited to an aerial flight type such as a drone, and may be a vehicle that runs on the floor or a vehicle that moves on a track laid on the floor or ceiling.

In addition, the photographing mechanism control apparatus 10 of at least one embodiment includes a control device such as a CPU, a storage device such as a ROM and a RAM, an external storage devices such as a HDD and a CD driver, a display device such as a display, and an input device such as a keyboard and a mouse, and has a hardware configuration using a normal computer.

The program executed by the photographing mechanism control apparatus 10 of at least one embodiment may be provided by being recorded in a computer-executable recording medium such as a CD-ROM, a FLOPPY (registered trademark) disk (FD), a CD-R, or a Digital Versatile Disk (DVD) in a computer-installable or computer-executable file format after the hardware configuration is completed.

In addition, the program executed by the information processing apparatus of at least one embodiment may be configured to be provided by being stored in a computer connected to a network, such as the Internet, and may be configured to be provided downloading via the network. In addition, the program executed by the information processing apparatus of at least one embodiment may be configured to be provided or distributed via a network, such as the Internet.

In addition, the program in at least one embodiment may be configured to be provided by being stored in a ROM or the like in advance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A photographing mechanism control apparatus comprising:
an interface configured to communicate with a photographing mechanism that is movable to a position according to an instruction to photograph a shelf for storing commodities; and
a processor configured to:
detect presence of a moving object in a vicinity of the shelf,
when the presence of the moving object is detected, instruct the photographing mechanism to photograph the shelf through the interface,
acquire image data from the photographing mechanism through the interface, and
confirm whether a commodity is stored on the shelf based on the image data.

2. The apparatus according to claim 1, wherein the image data includes at least one code indicating the presence of the shelf.

3. The apparatus according to claim 1, wherein the processor is configured to determine whether or not the commodity is out of stock or in a shortage state based on the image data.

4. The apparatus according to claim 3, wherein the processor is configured to, when it is determined that the commodity is out of stock or in the shortage state, cause an alert to be communicated.

5. A photographing mechanism control apparatus comprising:
an interface configured to communicate with a photographing mechanism that is movable to a position according to an instruction to photograph a shelf for storing commodities; and
a processor configured to:
detect a presence of a moving object in a vicinity of the shelf,
when the presence of the moving object is detected, determine whether or not the moving object is holding a commodity from a shelf,
when it is determined that the moving object is holding a commodity, instruct the photographing mechanism to photograph the shelf through the interface,
acquire image data from the photographing mechanism through the interface, and
confirm whether a commodity is stored on the shelf based on the image data.

6. The apparatus according to claim 5, wherein
the detecting of the presence of the moving object in the vicinity of the shelf includes
determining whether or not the moving object in the vicinity of the shelf is a customer.

7. The apparatus according to claim 5, wherein
the processor further is configured to provide a notification according to a result in which the commodity is stored on the shelf.

8. The apparatus according to claim 2, wherein
the detecting of the presence of the moving object in the vicinity of the shelf includes
determining whether or not the moving object in the vicinity of the shelf is a customer.

9. The apparatus according to claim 2, wherein
the processor further is configured to provide a notification according to a result in which the commodity is stored on the shelf.

10. The apparatus according to claim 5, wherein the image data includes codes indicating the presence of the shelf.

11. The apparatus according to claim 5, wherein the processor is configured to determine whether or not the commodity is out of stock or in a shortage state based on the image data.

12. The apparatus according to claim 11, wherein the processor is configured to, when it is determined that the commodity is out of stock or in the shortage state, cause an alert to be communicated.

13. A photographing mechanism control method for controlling a photographing mechanism that is movable to a position according to an instruction to photograph a shelf for displaying commodities, the method comprising:
detecting the presence of a moving object in a vicinity of the shelf;
when the presence of the moving object is detected, instruct the photographing mechanism to photograph the shelf;
acquiring image data from the photographing mechanism, and
confirming a commodity stored on the shelf based on the image data.

14. The method according to claim 13, wherein
the detecting of the presence of the moving object in the vicinity of the shelf includes
determining whether or not the moving object in the vicinity of the shelf is a customer.

15. The method according to claim 13, further comprising providing a notification according to a result in which the commodity is stored on the shelf.
